(19) United States
(12) Patent Application Publication
(10) Pub. No.: US 2020/0311723 A1
(43) Pub. Date: Oct. 1, 2020

(54) SYSTEMS AND METHODS FOR BLOCKCHAIN-BASED TRADING OF PORTFOLIOS

(71) Applicant: ETF Global Technologies, LLC, Bainbridge Island, WA (US)

(72) Inventors: Todd Miller, Ladera Ranch, CA (US); Larry Snyder, Bainbridge Island, WA (US)

(21) Appl. No.: 16/366,928

(22) Filed: Mar. 27, 2019

(51) Int. Cl. G06Q 20/38; G06Q 40/04

(52) U.S. Cl. CPC G06Q 20/389; G06Q 2220/00; G06Q 40/04

(57) ABSTRACT

Systems, methods, and computer-readable storage media facilitating blockchain-based management a portfolio of traded assets are disclosed. In embodiments, a primary authorized participant server may maintain a blockchain comprising blocks storing data associated with holdings of a portfolio of traded assets. Authorized participants may access the holdings files recorded to the blockchain and execute the holdings files against one or more rules engines to manage trading activities and initiate operations to align the portfolio of traded assets with one or more goals. The immutable records recorded to the blockchain may facilitate enhanced transparency and auditing while mitigating front-running and free-riding which could potentially have a negative impact on the portfolio.

### TECHNICAL FIELD

The present disclosure relates generally to trading processes for portfolios of traded assets and more specifically to systems and methods for providing secure and transparent management of trading activity for a portfolio of traded assets.

### BACKGROUND

Technology-based trading systems have become widespread and enable various market participants (e.g., individuals, institutional investors, etc.) to buy and sell traded assets such as stocks, bonds, exchange traded funds (ETFs), mutual funds, and the like. While these trading systems have provided significant advantages to the market participants in the form of convenience, speed of execution, and accessibility, modern technology-based trading systems still suffer from several drawbacks. To illustrate, the Securities and Exchange Commission (SEC) has imposed regulations that govern various aspects of how traded assets are purchased, sold, etc. Some general examples of regulation by the SEC include restrictions on insider trading and imposing disclosure requirements on certain entities associated with traded assets. Due to the widespread availability of publicly available trading systems, some traded assets may be negatively impacted by the regulations imposed by the SEC. For example, portfolios of traded assets (e.g., ETFs) may be structured or configured to a specific goal, such as tracking the performance an index (e.g., the S&P 500), and managing entities for these portfolios of traded assets may be required to publicly disclose the traded assets held in the portfolio. Such public disclosure may enable third party market participants (e.g., traders that are not associated with the portfolio of traded assets) to implement actions (e.g., front-running and/or free-riding) that could negatively impact the portfolio and its performance (e.g., increasing costs, etc.). Thus, the widespread availability of trading systems coupled with disclosure requirements mandated by government regulations may have a negative impact on various types of traded assets, such as portfolios of traded assets and ETFs in particular.

### SUMMARY

In the disclosed embodiments, systems, methods and computer-readable storage media providing increased data security and transparency with respect to a portfolio of traded assets are disclosed. In the disclosed embodiments, a primary authorized participant server may be configured to maintain holdings data related to the quantities of traded assets held in the portfolio and other information in an encrypted format on a blockchain that is accessible to authorized users (e.g., regulatory authorities, liquidity providers facilitating operations to maintain the portfolio, third party auditors, and the like). The primary authorized participant server may be configured to periodically retrieve a copy of the holdings from the blockchain and distribute the holdings file to one or more primary authorized participant servers that are configured to initiate various operations configured to align the portfolio with its designated goals, such as to ensure that the net asset value of the portfolio is equivalent to the net asset value of the underlying assets held in the portfolio. The primary authorized participant server may include one or more rules engines that are configured for execution against the holdings file received from the primary authorized participant server to determine which operations are to be performed in order to align the portfolio with the relevant goals. Such operations may include purchasing quantities of the underlying traded assets and exchanging the quantities of traded assets for additional shares of the portfolio that can be sold via a marketplace, which may be a trading platform facilitating the purchase of traded assets (including purchases of the shares of the portfolio). The operations may also include purchasing a quantity of shares of the portfolio from a marketplace and redeeming the shares of the portfolio for an equivalent value of traded assets held in the portfolio, which may be subsequently sold by the primary authorized participant server via the marketplace. The operations performed by the primary authorized participant server may be designed to impose upwards or downwards pressure on the shares of the portfolio and/or the underlying traded assets in order to drive the values towards equilibrium (e.g., so that the value of the shares of the portfolio accurately reflects the value of the underlying traded assets held in the portfolio).

To prevent third party marketplace participants from significantly impacting the performance of the portfolio, the holdings data written to the blockchain may be encrypted so that only authorized users (e.g., the primary authorized participant servers or other select entities) can access the data of the holdings file, which discloses the underlying traded assets and the quantities of each of the underlying traded assets held in the portfolio. This may prevent front-running, where a third party marketplace participant is able to predict future trade operations to be performed by the primary authorized participant servers and then execute those trades prior to their execution by the primary authorized participants. Additionally, this may mitigate free-riding, where a third party market participant copies the actions of the primary authorization servers, which may be especially pertinent to actively managed portfolios of traded assets.

The immutable records of the blockchain may further enable robust auditing to be performed to verify the performance and integrity of the portfolio. For example, the blocks of the blockchain may provide a historical record of the quantities of each traded asset held in the portfolio, as well as changes to those quantities over time. Auditing operations may be performed using this information in conjunction with historical marketplace data related to the underlying traded assets to, amongst other things, verify whether the operations executed by the primary authorization servers actually align the portfolio with its configured goals (e.g., tracking an index or some other desired property of the portfolio).

The foregoing has outlined rather broadly the features and technical advantages of the present invention in order that the detailed description that follows may be better understood. Additional features and advantages will be described hereinafter which form the subject of the claims. It should be appreciated by those skilled in the art that the conception and specific embodiment disclosed may be readily utilized as a basis for modifying or designing other structures for carrying out the same purposes of the present application. It should also be realized by those skilled in the art that such equivalent constructions do not depart from the spirit and scope of the application as set forth in the appended claims. The novel features which are believed to be characteristic of embodiments described herein, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present embodiments.

### BRIEF DESCRIPTION OF THE DRAWINGS

For a more complete understanding, reference is now made to the following descriptions taken in conjunction with the accompanying drawings, in which:

FIG. 1 is a block diagram of a system facilitating secure and transparent trading of a portfolio of traded assets in accordance with embodiments;

FIG. 2 is a block diagram illustrating an exemplary processing flow for executing a creation operation in accordance with embodiments;

FIG. 3 is a block diagram illustrating an exemplary processing flow for executing a redemption operation in accordance with embodiments;

FIG. 4 is a flow diagram of an exemplary method for blockchain-based management of a portfolio of traded assets in accordance with embodiments; and

FIG. 5 is flow diagram of an exemplary method for blockchain-based management of a portfolio of traded assets in accordance with embodiments.

### DETAILED DESCRIPTION

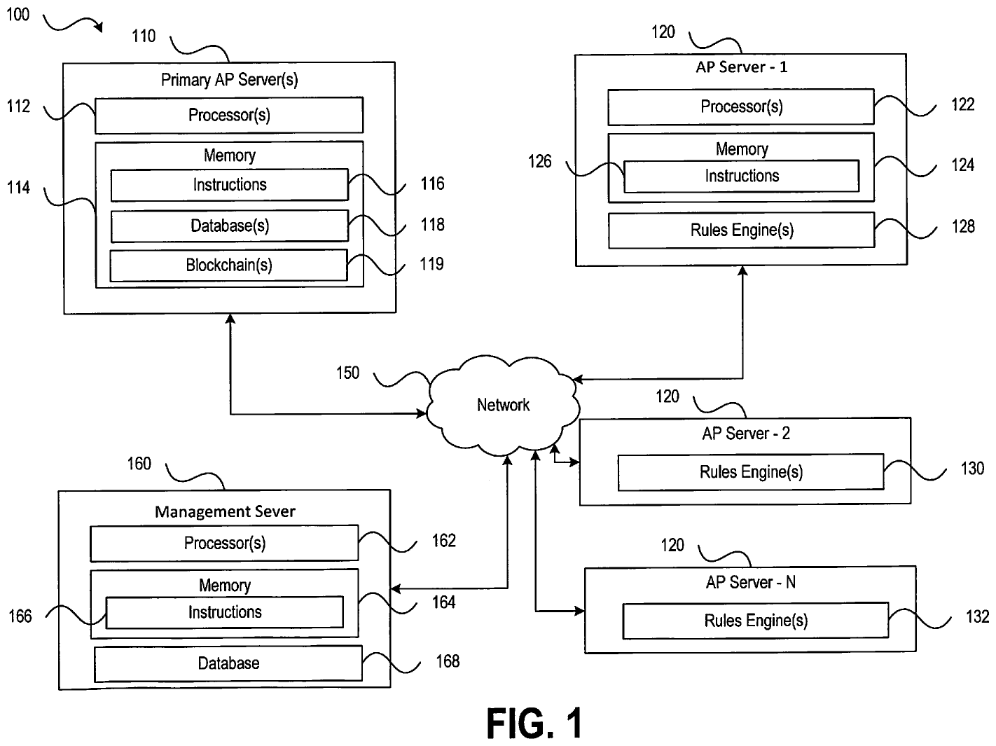

Referring to FIG. 1, a block diagram of a system facilitating secure and transparent trading of a portfolio of traded assets in accordance with embodiments is shown as a system 100. As shown in FIG. 1, the system includes a primary authorized participant server 110, a plurality of authorized participant servers 120, one or more marketplace servers 140, and a management server 160. A network 150 may communicatively couple each these servers to facilitate various operations of the system 100, as described in more detail below.

The primary authorized participant server 110 may include one or more processors 112 and a memory 114. Each of the one or more processors 112 may be a central processing unit (CPU) having one or more processing cores. The memory 114 may include read only memory (ROM) devices, random access memory (RAM) devices, one or more hard disk drives (HDDs), one or more flash memory devices, one or more solid state drives (SSDs), one or more network attached storage (NAS) devices, other devices configured to store data in a persistent or non-persistent state, or a combination of different memory devices. The memory 114 may store instructions 116 that, when executed by the one or more processors 112, cause the one or more processors 112 to perform operations described in connection with the primary authorized participant server 110 with reference to FIGS. 1-5. Additionally, the memory 114 may be utilized to provide one or more databases 118 and a blockchain 119. Exemplary aspects of the one or more databases 118 and the blockchain 119 are described in more detail below.

As shown in FIG. 1, the plurality of authorized participant servers 120 includes a first authorized participant server (PAP Server-1), a second authorized participant server (PAP Server-2), and an Nth authorized participant server (PAP Server-N). It is noted that although FIG. 1 illustrates the system 100 as including three authorized participant servers 120, embodiments of the present disclosure may include more than three authorized participant servers 120 or less than three authorized participant servers. Additionally, it is noted that while portfolios of traded assets typically utilize two or more authorized participants, the system 100 may be configured to include a single authorized participant server if desired.

As illustrated in FIG. 1 with respect to the first authorized participant server (PAP Server-1), each of the authorized participant servers 120 may include one or more processors 122, a memory 124, and one or more rules engines (e.g., rules engines 128, 130, 132). Each of the one or more processors 122 may be a CPU having one or more processing cores. The memory 124 may include ROM devices, RAM devices, one or more HDDs, one or more flash memory devices, one or more SSDs, one or more NAS devices, other devices configured to store data in a persistent or non-persistent state, or a combination of different memory devices. The memory 124 may store instructions 126 that, when executed by the one or more processors 122, cause the one or more processors 122 to perform operations described in connection with the authorized participant server 120 with reference to FIGS. 1-5. As described in more detail below, each of the one or more rules engines may be configured for execution against an input data set to derive one or more actions to be performed with respect to a portfolio of traded assets and one or more modifications to the portfolio of traded assets may be realized as a result of the actions. For example, the first authorized participant server includes one or more rules engines 128, the second authorized participant server (PAP Server-2) includes one or more rules engines 130, and the Nth authorized participant server (PAP Server-N) includes one or more rules engines 132. It is noted that although FIG. 1 illustrates each of the three authorized participant servers as including one or more rules engines (e.g., rules engines 128, 130, 132), systems configured in accordance with embodiments may include authorized participant servers that include different numbers of rules engines. For example, some authorized participant servers may include one rules engine, while other authorized participant servers may include more than one rules engine. Additional details regarding operation of the authorized participant servers 120 and the one or more rules engines are described below.

The one or more marketplace servers 140 may include one or more processors 142 and a memory 144. Each of the one or more processors 142 may be a CPU having one or more processing cores. The memory 144 may include ROM devices, RAM devices, one or more HDDs, one or more flash memory devices, one or more SSDs, one or more NAS devices, other devices configured to store data in a persistent or non-persistent state, or a combination of different memory devices. The memory 144 may store instructions 146 that, when executed by the one or more processors 142, cause the one or more processors 142 to perform operations described in connection with the one or more marketplace servers 140 with reference to FIGS. 1-5. The one or more marketplace servers 140 may facilitate trading activities with respect to various traded assets, including shares of portfolios of traded assets. For example, the one or more marketplace servers 140 may provide one or more marketplaces (e.g., web-based marketplaces or other trading platforms) that enable members of the public or institutional investors to purchase stocks, shares of portfolio traded assets (e.g., ETFs, mutual funds, etc.), and other traded assets.

The management server 160 may include one or more processors 162 and a memory 164. Each of the one or more processors 162 may be a CPU having one or more processing cores. The memory 164 may include ROM devices, RAM devices, one or more HDDs, one or more flash memory devices, one or more SSDs, one or more NAS devices, other devices configured to store data in a persistent or non-persistent state, or a combination of different memory devices. The memory 164 may store instructions 166 that, when executed by the one or more processors 162, cause the one or more processors 162 to perform operations described in connection with the management server 160 with reference to FIGS. 1-5. As described below, the management server 160 may be operated by an entity that issues a portfolio of traded assets and may be configured to issue shares of a portfolio of traded assets to one or more authorized participants (e.g., operators of the one or more authorized participant servers 120) in exchange for quantities of traded assets held in the portfolio or provide quantities of traded assets held in the portfolio of traded assets to one or more authorized participants (e.g., operators of the one or more authorized participant servers 120) in exchange for shares of the portfolio.

In embodiments, the management server 160 may be operated by an entity that issues portfolios of traded assets. As an example, suppose that an entity desires to issue a portfolio of traded assets, such as an exchange traded fund (ETF). The entity may structure the ETF to track a particular index, such as the S&P 500 index, or to have some other desired goal or metric of performance. To issue the portfolio of traded assets (e.g., the ETF), the issuer may work with one or more authorized participants (also referred to as liquidity providers), such as large financial institutions (e.g., banks), to obtain traded assets, such as stocks, corresponding to the particular index or other configured goal(s) of the portfolio. It is noted that where the particular index is composed of a particular ratio of traded assets, the authorized participants may purchase the traded assets in proportion to the particular ratio of traded assets associated with the particular index. Having acquired the traded assets, the authorized participants may provide the traded assets to the issuer in exchange for a quantity of shares of the portfolio of traded assets (e.g., shares of the ETF). Once the authorized participants receive the shares of the portfolio of traded assets, the authorized participants may sell the shares, such as by offering them for sale via the one or more marketplace servers 140.

As a result of the processes described above, the issuer of the portfolio of traded assets obtains holdings corresponding to the quantities of traded assets received from the authorized participants. Upon receiving the holdings, the issuing entity may create a traded holdings file that indicates the quantities of each of the traded assets held in the portfolio. In addition to recording the quantities of each of the traded assets, the traded holdings file may include additional information, such as one or more timestamps, a purchase price at which each of the traded assets was acquired, a rules engine utilized to effect the purchase of the traded assets (or a portion thereof), or other information. The timestamps may include date information (e.g., the date on which a particular quantity of a traded asset was acquired or received from a primary authorized participant), time information (e.g., the time at which the particular quantity of the traded assets was acquired or received from a primary authorized participant), or both date information and time information. It is noted that portions of the holdings may be acquired at different times, on different dates, and by different authorized participants. This may occur for a variety of reasons, such as through changes in the holdings corresponding to the portfolio over time, acquiring different portions of the holdings through different rules engines of different authorized participants, changes in the strategy or configuration of the portfolio goals, or for other reasons. For example, at the end of each day a traded holdings file reflecting all activity executed with respect to the portfolio of traded assets may be generated (e.g., a daily traded holdings file) and intraday traded holdings files may be generated periodically during each trading day as changes to the portfolio occur due to operations of system 100, such as changes made to the configuration of the portfolio (e.g., modifying a ratio of one or more traded assets held in the portfolio or modifying a makeup of the holdings of the portfolio).

The traded holdings file may also include information that identifies one or more exchanges (e.g., marketplace servers 140) utilized by the authorized participant servers 120 to effect the transactions (or outcomes) determined by the one or more rules engines. To illustrate, each of the one or more rules engines of the different authorized participant servers 120 may be configured to receive a holdings file, which may be generated based on trading activity from the previous day or based on intraday trading activity. As described in more detail below, the one or more rules engines may be configured to execute a set of rules against a received holdings file to determine one or more operations, such as creation, redemption, and arbitrage operations, to be initiated to manage aspects of the portfolio of traded assets in accordance with the configured goals of the portfolio and may utilize the one or more exchanges facilitated by the one or more marketplace servers 140 to execute the one or more operations. It is noted that portions of the operations resulting from the execution of the one or more rules engines may be performed at different exchanges depending on market conditions. For example, if certain trading operations would be more advantageous (e.g., from a cost perspective, a trade execution time perspective, a market demand perspective—demand for a traded asset may be greater at one exchange than another, enabling the trade to be completed swiftly due to the higher demand, or other factors) at a first exchange while other trades would be more advantageous at a second exchange, portions of the trading operations that would be more advantageous at the first exchange may be performed via the first exchange while other trade operations may be performed via the second exchange. Thus, multiple exchanges may be utilized to execute trading activities associated with the actions determined by the one or more rules engines based on the holdings file. Including information regarding the particular exchange utilized for a particular transaction may increase the transparency of the operations of the system 100 and enhance the quality of information provided during audits of the system 100. It is noted that trade information may indicate or associate particular transactions with particular exchanges, as well as rules engines, such as to associate at least a portion of a transaction with a specific rules engine of the one or more rules engines. It is noted that marketplace servers utilized to facilitate operations of the system 100 may include dark pools and that the indication of the particular marketplace server, whether a dark pool or not, may be indicated in the holdings file.

As trading data is received from the authorized participant servers 120, it may be compiled into a traded holdings file and stored in the database 168 associated with the management server 160. The traded holdings file may additionally be provided to the primary authorized participant server 110, which may write the holdings file or information associated with the holdings file to the blockchain 119. In an aspect, the holdings file written to the blockchain 119 may be different from the holdings file stored in the database 168. For example, the blockchain 119 may facilitate third party access, such as by the authorized participant servers 120, to the information of the holdings file written to the blockchain. As such, the holdings file written to a block of the blockchain 119 may include less information than may be included in the holdings file stored in the database 168. For example, one or more pieces of information (e.g., information regarding the particular rules engine utilized to acquire a particular portion of the traded assets held in the portfolio) included in the traded holdings file stored in the database 168 may be redacted prior to providing the holdings file to the primary authorized participant server 110 and writing the holdings file to the blockchain 119. As an example, the holdings file received by the primary authorized participant server 110 may include information that identifies the traded assets held in the portfolio and information associated with the makeup or configuration of the portfolio.

The information that identifies the traded assets held in the portfolio may include a list of ticker symbols, a list of Committee on Uniform Securities Identification Procedures (CUSIP) identifiers, or other information that may identify the traded assets held in the portfolio and the information that identifies the makeup or configuration of the portfolio may include a percentage associated with each traded asset (e.g., what percentage of the portfolio is made up of the corresponding traded asset). For example, if a portfolio includes 3 traded assets (e.g., asset-1, asset-2, and asset-3), the holdings file received by the primary authorized participant server 110 and written to the blockchain 119 may include identifiers for each of the 3 traded assets (e.g., an identifier “ABC” may correspond asset-1, an identifier “DEF” may correspond to asset-2, and an identifier “EFG” may correspond to asset-3) as well as information that identifies the makeup or configuration of the portfolio (e.g., asset-represents 40% of the portfolio, asset-2 represents 35% of the portfolio, and asset-3 represents 25% of the portfolio). It is noted that the particular manner of indicating the makeup or configuration of the portfolio may be achieved in a variety of ways and is not limited to percentages. For example, the information may be indicated by specifying the total quantity of traded assets held in the portfolio and the quantities of each individual traded asset held in the portfolio, by indicating only the quantities of each traded asset held in the portfolio, as percentages (as described above), other types of information, or combinations of these types of information. It is noted that redacting information from the holdings file that may be irrelevant to the third parties accessing the holdings file via the blockchain 119 may reduce the likelihood that the use of the holdings file by third parties is tainted or influenced by the irrelevant information.

The database 118 of the primary authorized participant server 110 may include information that identifies particular authorized participant server(s) 120 that are authorized to receive holdings file information stored at the blockchain 119. In an aspect, the holdings file may be encrypted prior to being written to the blockchain 119. Encryption of the holdings file may be performed using an advanced encryption standard (AES) 256 bit cipher or another encryption technique depending on the particular configuration of the system 100. It is noted that the particular block of the blockchain 119 to which the holdings file is written may include information that identifies a first or previous block of the blockchain. Accordingly, as changes to the holdings file are made over time, such as due to changes in the makeup of the traded assets of the portfolio (e.g., changes to the quantities of traded assets, changes to the traded assets included in the portfolio, etc.), each iteration of the holdings of the portfolio are recorded to a new block of the blockchain 119 and each block of the blockchain 119 links to a previous block of the blockchain 119 corresponding to a previous iteration of the holdings of the portfolio. Further, it is noted that each block of the blockchain 119 may be timestamped with information (e.g., date information, time information, or both) corresponding to when the block was created. These immutable records (e.g., the blocks of the blockchain 119) may enable auditing of the portfolio, as described in more detail below.

In an aspect, rather than writing the holdings file to the portfolio of traded assets, the primary authorized participant server 110 may be configured to encrypt and store the holdings file (or the redacted version of the holdings file) to the database 118 and record a hash of the holdings file to the blockchain 119. In such an arrangement, distribution of the holdings files to the authorized participant servers 120 may be facilitated from the encrypted holdings files recorded at the database 118, rather than from the blockchain 119. By recording a hash of the holdings file on the blockchain 119, the authenticity of the holdings files stored in the database 118 and/or the database 168 may be determined. To illustrate, suppose that a holdings file is recorded to the database 118 and a hash of the holdings file is recorded on the blockchain 119. If the authenticity of the holdings file needs to be determined at a subsequent time, such as during an audit, the holdings file may be retrieved from the database 118 and hashed. The resulting hash value may be compared to the hash of the holdings file recorded to the blockchain 119 to establish the holdings file distributed to the authorized participant servers 120 was not altered (e.g., if the two hashes match the authenticity of the holdings file may be established and if the two hashes do not match the holdings file may be determined to have been altered prior to or subsequent to distribution to the authorized participant servers 120). Additionally, writing a hash to the blockchain may minimize the size of the blockchain 119 and facilitate more cost effective administration of the blockchain 119. It is noted that the blockchain 119 may be a public blockchain or a private blockchain. In an aspect, a hash of the holding file may be recorded in the database 118 and the encrypted holdings file may be recorded to the blockchain 119. Such an arrangement would facilitate authentication of the holdings file in a manner similar to the technique described above, except the hash value is recorded in the database 118 and the holdings file is stored on the blockchain 119, rather than the other way around in the example above.

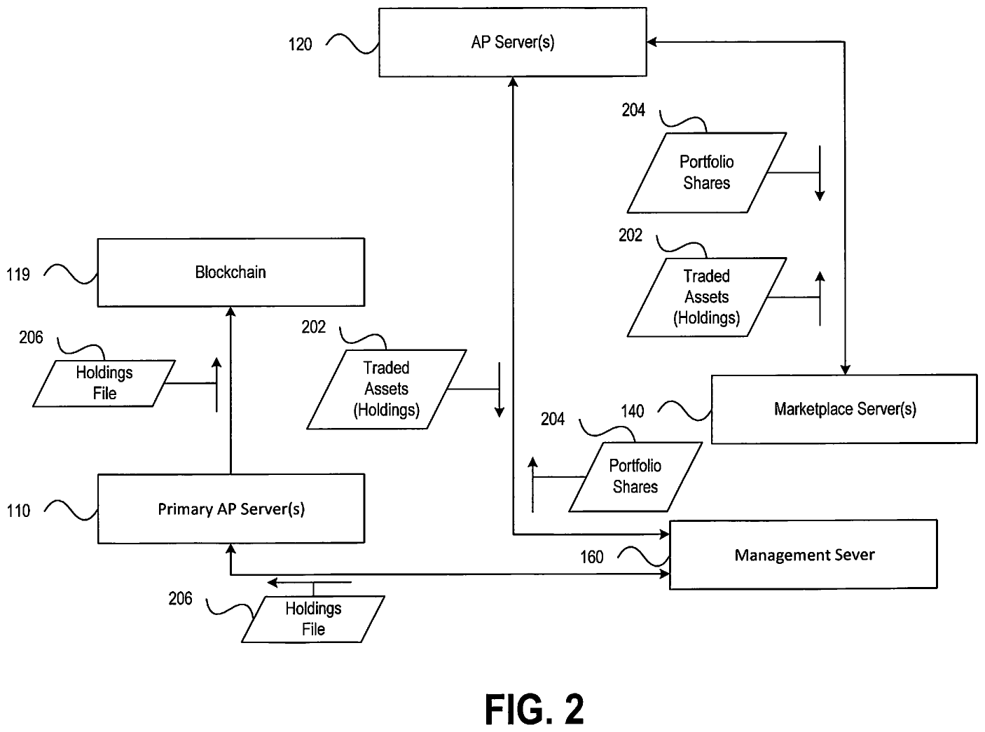

Referring briefly to FIG. 2, a block diagram illustrating an exemplary process for issuing a portfolio of traded assets in accordance with embodiments is shown. As shown in FIG. 2, during issuance of the portfolio of traded assets, quantities of one or more traded assets 202 are acquired by the authorized participant server(s) 120, such as by buying stocks or other traded assets via the one or more marketplace servers 140. The quantities of one or more traded assets 202 may be provided to the management server 160 and a quantity of portfolio shares 204 may be provided to the authorized participant server(s) 120. The quantity of portfolio shares 204 may then be sold by the authorized participant server(s) 120 via the marketplace server(s) 140. Upon receiving the quantities of one or more traded assets 202, the management server 160 may create a holdings file 206 (or update a previous holdings file) that identifies the quantities of the one or more assets 202, as described above. The holdings file 206 may be stored in the database 168 (not shown in FIG. 2) and may also be provided to the primary authorized participant server 110, which may write the holdings file 206 to the blockchain 119 (or store the holdings file 206 at the database 118 and write a hash of the holdings file 206 to the blockchain 119). As explained above with reference to FIG. 1, the holdings file may be encrypted prior to being written to the blockchain 119, the database 118, or both.

Referring back to FIG. 1, the makeup of the portfolio of assets and the outstanding quantity of shares of the portfolio may change over time due to operations initiated by the authorized participant servers 120. For example, the portfolio of traded assets may be configured by the issuing entity to track the performance of the underlying traded assets held in the portfolio. One of the roles of the authorized participant servers 120 may be to monitor the value of the portfolio (or the value of the portfolio shares) relative to the values of the underlying traded assets and to ensure that the value of the portfolio (or the portfolio shares) is in line with the net asset value (NAV) of the underlying shares. To facilitate this role, the authorized participant servers 120 may be configured to periodically receive the holdings file recorded on the blockchain 119 (or the database 118) from the primary authorized participant server 110 and execute the one or more rules engines against the holdings file (or portions thereof). For example, each of the rules engines may be configured to monitor all or a portion of the traded assets held in the portfolio and to initiate various operations to harmonize the NAV of the portfolio with the underlying assets. The operations initiated by the authorized participant server 120 may include creation and redemption operations.

In a creation operation, the authorized participant server 120 may purchase quantities of the underlying traded assets (e.g., as may be determined by execution of one or more rules engines against the holdings file) and provide the quantities of the underlying traded assets to the management server 160 in exchange for a quantity of shares of the portfolio. It is noted that creation operations may be performed based on specific unit sizes or blocks. For example, if the block or unit size is 50,000, a creation operation may result in the authorized participant server 120 purchasing quantities of traded assets having a value equal to the block or unit size (e.g., 50,000) of the portfolio shares. The quantities of traded assets may then be provided (e.g., as a creation unit) to the management server 160 in exchange for the block of shares of the portfolio. In this manner, the portfolio obtains traded assets needed to maintain its intended configuration (e.g., properly tracking the index or other target or goal specified for the portfolio) and the primary authorized participant obtains portfolio shares that may be sold (e.g., for a profit). As explained above, the creation operation may result in changes to the makeup of the portfolio, such as by increasing quantities of traded assets held in the portfolio. Accordingly, when creation operations are performed, the management server 160 may generate an updated holdings file, which may be stored at the database 168 and provided to the primary authorized participant server 110, which may write the holdings file (or a hash of the holdings file) to a new block on the blockchain 119. It is noted that the creation operation may be performed in a manner similar to the operations illustrated in FIG. 2.

One or more of the rules engines may initiate the creation process in response to a determination that the current market price of the portfolio shares exceeds the net asset value of the underlying trade assets held in the portfolio (e.g., the market price of the portfolio shares are “overpriced” or out of line with the net asset value of the underlying trade assets). Through the creation process, an authorized participant server 120 may initiate a purchase of additional quantities of the traded assets to form a creation unit, exchange the creation unit for a quantity of portfolio shares, and sell the obtained quantity of portfolio shares via the marketplace server(s) 140. Selling the quantity of portfolio shares obtained by the creation process may place downward pressure on the market price of the shares of the portfolio while buying the quantities of traded assets may place upward pressure on the value of the traded assets, thereby driving the price of the portfolio shares to a value that is more in line with the net asset value of the traded assets held in the portfolio.

In a redemption operation, an authorized participant server 120 may purchase a quantity of portfolio shares via the marketplace server(s) 140 and provide the quantity of portfolio shares to the management server 160 in exchange for quantities of the underlying traded assets held in the portfolio. It is noted that redemption operations may be performed based on specific unit sizes or blocks. For example, if the block or unit size is 50,000, a redemption operation may result in the authorized participant server 120 purchasing a redemption unit (e.g., 50,000 shares of the portfolio). The redemption unit of portfolio shares may then be provided from the authorized participant server 120 to the primary authorized participant server 110 in exchange for quantities of the underlying traded assets having an equivalent value with respect to the redemption unit. In this manner, the portfolio is maintained in its intended configuration (e.g., properly tracking the index or other target or goal specified for the portfolio) and the primary authorized participant obtains additional traded assets that may be sold (e.g., for a profit). For example, buying the quantity of portfolio shares may place upward pressure on the market price of the shares of the portfolio while selling the quantities of traded assets may place downward pressure on the value of the traded assets, thereby driving the price of the portfolio shares to a value that is more in line with the net asset value of the traded assets held in the portfolio.

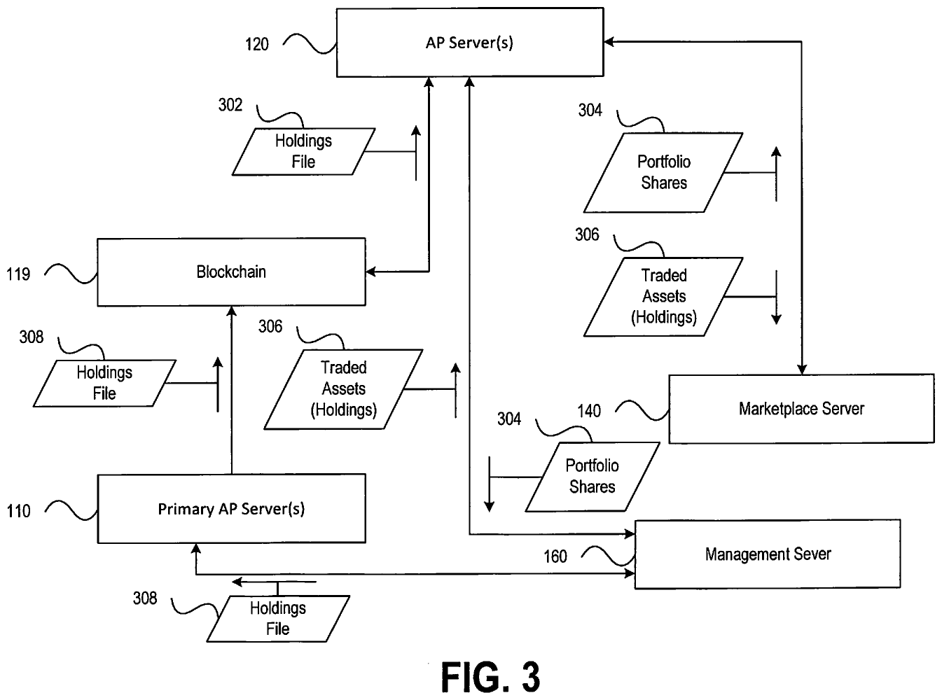

Referring briefly to FIG. 3, a block diagram illustrating an exemplary processing flow for a redemption operation is shown. In the exemplary redemption process shown in FIG. 3, the authorized participant server(s) 120 may obtain a holdings file 302 from the blockchain 119. As described above, the holdings file 302 may be encrypted and in such instances, the primary authorized participant may decrypt the holdings file 302 prior to executing the one or more rules engines against the holdings file 302. Alternatively, the holdings file 302 may be provided from the database 118, as described above. As a result of execution of the one or more rules engines against the holdings file 302, the authorized participant server(s) 120 may initiate a redemption operation. Upon a determination to initiate the redemption operation, the authorized participant server(s) 120 may purchase a quantity of portfolio shares 304 from the marketplace server(s) 140 and provide the quantity of portfolio shares 304 to the management server 160 and in return a quantity of traded assets 306 may be provided to the authorized participant server 120. As shown in FIG. 3, once received, the authorized participant server 120 may then sell the quantity of traded assets 306 via the marketplace server(s) 140. The management server 160, upon receiving the quantity of portfolio shares 304 from and providing the quantities of traded assets 306 to the authorized participant server 120 may generate an updated holdings file 308, which may be stored at the database 168 and provided to the primary authorized participant server 110. The primary authorized participant server 110 may write the holdings file 308 to a new block of the blockchain 119 or may write a hash of the holdings file 308 to the blockchain 119 and record the holdings file 308 at the database 118. As described above, the new block corresponding to the holdings file 308 may include a reference to a previously generated block, which may be the block from which the holdings file 302 was retrieved or a different block (e.g., if other modifications to the holdings file occurred before the redemption operation and were written to the blockchain 119 or for other reasons).

In an embodiment, the primary authorized participant server 110 may be configured to distribute the holdings file(s) to the one or more rules engines at particular times depending on whether the holdings file is based on a daily holdings file (e.g., a primary holdings file) or an intra-day holdings file. The daily holdings file may correspond to a holdings file generated following netting operations configured to settle all transactions executed with respect to the portfolio for a particular day. Stated another way, the daily or primary holdings file may represent a current status of the holdings of the portfolio at the beginning of a particular day. An intra-day holdings may be configured to reflect changes that occurred during a particular day and may be generated prior to the netting operations for the particular day. For example, following distribution of a holdings file generated based on the primary holdings file (i.e., a primary traded holdings file) to the one or more rules engines various transactions may be executed that result in changes to the holdings of the portfolio. At the end of the trading day, a new primary holdings file may be generated that reflects the trading activity performed by the authorized participants in response to distribution of the holdings file from the blockchain 119. In some instances, the issuer (e.g., the entity operating the management server 160) may alter the configuration or makeup of the portfolio and may provide an intraday holdings file to the primary authorized participant server 110. That holdings file may be written to the blockchain 119 (or both the blockchain 119 and the database 118), as described above, and then distributed to the authorized participant servers 120 to notify the authorized participants of the changes to the configuration of the portfolio. At the end of the trading day, the authorized participant servers 120 may communicate trading information that includes trading activity based on the holdings file distributed at the start of the trading day and may include trading activity based on the intraday holdings file distributed in response to modification of the makeup or configuration of the portfolio the management server 160. It is noted that creation and distribution of intra-day holdings files may vary from one day to the next. To illustrate, on some days one or more intra-day holdings files may be created and distributed by the system 100 and on other days no intra-day holdings files may be created.

In an aspect, distribution of holdings files (e.g., daily holdings files and intra-day holdings files) may be initiated via an application providing access to blocks of the blockchain 119. The distribution may be initiated prior to an opening of trading sessions at the one or more marketplace servers 140. For example, if trading via the one or more marketplace servers 140 opens at 9:00 AM Eastern Standard Time (EST), the holdings files may be distributed to the one or more rules engines prior to 9:00 AM EST. The primary authorized participant server 110 may be configured to initiate distribution of the holdings files based on a threshold distribution time, which may correspond to an amount of time prior to the opening of trading at the one or more marketplace servers 140. For example, the threshold distribution time may be configured to initiate distribution of the daily holdings file one hour prior to the opening of the one or more marketplace servers 140. It is noted that the threshold distribution time of one hour described above has been provided for purposes of illustration, rather than by way of limitation that the threshold distribution time may be configured to a period of time that is greater than one hour or less than one hour.

In an aspect, the time period associated with the threshold distribution time may be configured based on an expected amount of time required by the one or more rules engines to process the holdings file. For example, if the one or more rules engines require “X” amount of time to ingest the holdings file as an input and process the holdings file to determine whether any trading operations are to be performed, the threshold distribution time may be configured to be at least “X” amount of time so that each of the one or more rules engines may be ingest and process the holdings file by the time the one or more marketplace servers 140 open. Distribution of the holdings file(s) to the one or more rules engines may be synchronized such that the holdings file(s) is received by each of the one or more rules engines at the same or substantially the same time in accordance with the configuration of the threshold distribution time.

The primary authorized participant server 110 may be configured to receive information from each of the one or more rules engines prior to distribution of the holdings files. For example, the liquidity providers associated with the one or more rules engines may periodically make changes to the sets of rules utilized by the one or more rules engines to evaluate the holdings file in view of current market conditions. As each of the one or more rules engines is modified, information indicating a version of the holdings file may be provided to the primary authorized participant server 110. The version information may be recorded at the database 118 and timestamped to indicate the particular version of each of the one or more rules engines utilized for a particular day. Additionally, prior to authorizing a primary authorize participant server 120 to receive holdings file information from the primary authorized participant server 110, each of the primary authorized participants may provide the primary authorized participant server 110 with a certification that the rules engine(s) utilized by the authorized participant server 120 is configured to execute the set of rules against the holdings file in an automated manner and that human intervention cannot be utilized to override the trade operations initiated by the rules engine(s) based on the holdings file(s).

In an aspect, the primary authorized participant server 110 may be configured to provide an application programming interface (API) that interfaces the application to the blockchain 119 to ensure secure distribution of the holdings files. The API may be code scanned and security tested by the primary authorized participant server 110 to ensure the holdings file is not tampered with or altered during distribution to the one or more rule engines. The API may be configured to read the appropriate holdings file from the blockchain 119, decrypt the holdings file, and then provide the decrypted holdings file to each of the one or more rules engines as an input. Alternatively, the primary authorized participant server 110 may be configured to retrieve the hash of the holdings file (e.g., from the blockchain 119 or database 118) and compare the retrieved hash to a hash calculated based on the holdings file that is to be distributed to the authorized participant servers 120. If the two hashes match, the holdings file may be authorized for distribution to the authorized participant server 120.

The primary authorized participant server 110 may also provide a portfolio configuration API that may be utilized to modify the makeup the portfolio of traded assets. For example, the entity that controls (or created) the portfolio of traded assets may change one or more characteristics of the portfolio of traded assets over time, such as to change the ratios of the underlying traded assets of the portfolio, add one or more new traded assets to the portfolio, remove one or more traded assets to the portfolio. When a modification to the makeup of the portfolio is performed via the API, information may be transmitted to the authorized participant server 120 to notify the liquidity providers of the changes made with respect to the portfolio. The liquidity providers, and more specifically the one or more rules engines of the authorized participant server 120, may initiate one or more trade operations to implement the changes made to the makeup of the portfolio, such as to purchasing quantities of one or more traded assets (e.g., quantities of new traded assets added to the portfolio or quantities of traded assets having an increased weight (or percentage) within the portfolio, and the like), sell quantities of one or more traded assets of the portfolio (e.g., quantities of traded assets removed from the portfolio or quantities of traded assets having an decreased weight (or percentage) within the portfolio, and the like), or other operations. As these trading operations are executed, updated holdings file data may be generated by the management server 160 and provided to the primary authorized participant server 110, which may write the holdings file (or a hash of the holdings file) to the blockchain 119, as described herein. It is noted that the API may be accessed via one or more graphical user interfaces, such as a web-based application presented within a web page or a standalone application executing on a user device communicatively coupled to the primary authorized participant server 110 via a network. Additionally, access to the API and the associated user interfaces may require authentication (e.g., a username and password, two-factor authentication, etc.) of a user prior to enabling a modification of the portfolio to be made.

Referring back to FIG. 1, the redemption process may be initiated in response to identifying an arbitrage opportunity (i.e., the net asset value of the underlying traded assets is out of line with respect to the value of the shares of the portfolio). For example, at least one of the one or more rules engines may be configured to implement arbitrage operations designed to detect instances when the current market price of the portfolio shares is lower than the net asset value of the underlying trade assets held in the portfolio (e.g., the market price of the portfolio shares are “underpriced” or out of line with the net asset value of the underlying trade assets). The authorized participant server 120 may perform a redemption operation that may include purchasing of a quantity of shares of portfolio, exchanging the quantity of shares of portfolio for quantities of the underlying assets, and selling the quantities of the underlying assets via the marketplace server(s) 140. Selling the quantities of the underlying assets obtained by the redemption process places downward pressure on value of the underlying traded assets while purchasing the quantity of the portfolio shares may create upward pressure on value of the portfolio shares, thereby driving the price of the portfolio shares to a value that is more in line with the net asset value of the traded assets held in the portfolio (e.g., the market price of the portfolio shares increases and the market prices of one or more of the underlying traded assets decreases).

As another example, the arbitrage operations may be configured to detect when the net asset value of the underlying trade assets held in the portfolio is lower than the current market price of the portfolio shares (e.g., the net asset value of the underlying assets is “underpriced” or out of line with value of the shares of the portfolio). Upon identifying such a situation, the rules engine(s) may perform a redemption operation that may include purchasing quantities of the underlying traded assets, exchanging the quantities of the underlying assets for a quantity of shares of portfolio, and selling the quantity of shares of portfolio via the marketplace server(s) 140. Selling the quantity of shares of portfolio quantities obtained by the redemption process places downward pressure on value of the portfolio shares and purchasing the quantities of underlying assets creates upward pressure on value of the underlying assets, thereby driving the price of the portfolio shares to a value that is more in line with the net asset value of the traded assets held in the portfolio (e.g., the market price of the portfolio shares decreases and/or the market prices of one or more of the underlying traded assets increases).

As explained above, creation operations and redemption operations may result in changes to the makeup of the portfolio, such by decreasing or increasing the quantities of traded assets held in the portfolio. Accordingly, when such operations are performed, the management server 160 may generate an updated holdings file, which may be provided to the primary authorized participant server 110 and stored at the database 118 and/or written to a new block on the blockchain 119, as described above.

As described above, trading activities initiated based on outcomes generated by the one or more rules engines may be performed multiple times during a given day, which results in creation of intraday holdings files. As the intraday holdings files are created, the primary authorized participant server 110 may store the intraday holdings files to a database 118 and/or write the intraday holdings files to the blockchain 119. Once written to the blockchain 119, the primary authorized participant server 110 may generate one or more notification messages associated with the intraday holdings file(s). A notification message may indicate an address on the blockchain 119 to which a recently created (or most recent created) intraday holdings file was written. The notification message may be transmitted from the primary authorized participant server 110 to the authorized participant server 120 via the network 150 and once the notification message is received by the authorized participant server(s) 120 to signal the availability of an updated holdings file (e.g., the intraday holdings file).

The one or more authorized participant servers 120 may be configured to retrieve intraday holdings file by requesting the primary authorized participant server 110 to provide the contents of the block associated with the addresses of the blockchain 119 included in the notification message and may utilize the information included in the retrieved intraday holdings file to initiate further operations with respect to the portfolio of traded assets, such as to initiate additional trading activity based on changes in real-time market conditions. The trading activity initiated based on the intraday holdings files may be conducted in a manner similar to the operations described above with respect to FIGS. 2 and 3. The real-time market conditions may be determined based on information obtained from the one or more marketplace servers 140, which may be obtained by the authorized participant server 120 and/or by the one or more rules engines.

It is noted that rules established by the Securities and Exchange Commission (SEC) permit persons to trade in certain specified circumstances where it is clear that the information they are aware of is not a factor in the decision to trade, such as pursuant to a pre-existing plan, contract, or instruction that was made in good faith. The system 100 alleviates concerns regarding insider trading based on selective disclosure (i.e., distributing the holdings file) because the rules engines utilized by the primary authorized participant servers are configured to initiate trading activities in accordance with a pre-existing plan (e.g., the configuration of the rules utilized by the rules engine to initiate trading operations with respect to the shares of the portfolio and/or the underlying assets of the portfolio).

The system 100 may be configured to provide fully transparent auditing of activities related to the portfolio. For example, creation operations, redemption operations, and other trading activities related to the portfolio may be audited and verified using the database 118 and/or the blockchain 119. To facilitate auditing and verification, the primary authorized participant server 110 may be configured to receive an audit request from an interested party, such as the SEC or an independent third party. The audit request may be received via an a web-based application, such as a utility or feature provided via a website operated by the managing entity, via an e-mail message, or via an application programming interface providing access to at least one of the database 118 and/or the blockchain 119. The audit request may identify a particular time period to be audited, such as identifying a particular date (e.g., a day) or range of dates (e.g., days, weeks, months, years, etc.) to be addressed by the audit. In response to receiving the audit request, the primary authorized participant server 110 may generate audit data corresponding to the time period identified in the audit request. For example, the primary authorized participant server 110 may initiate a search process configured to identify blocks of the blockchain 119 or records within the database 118 that correspond to the relevant time period and may generate the audit data based on the information obtained by the search process. It is noted that the rules engines may be deterministic—that is, given a set of inputs, such as the makeup of the portfolio as identified by the holdings file and current market conditions, each of the rule engines may produce the same outcomes. Accordingly, during an audit, the audit data, which may include information representative of an instance of the holdings file at a particular point in time relevant to the audit, may be executed against the one or more rules engines to verify the operations performed with respect to the portfolio, such as to verify the one or more rules engines were operating in accordance with their programmed functionality and that the actions initiated by the one or more rules engines were made to benefit the portfolio, such as to align the portfolio with its intended configuration (e.g., tracking a particular index, etc.).

It is to be appreciated that such a recreation of prior activity initiated by the one or more rules engines may utilize historical pricing data associated with the shares of the portfolio as well as the underlying traded assets and as such the audit data may include timestamp information associated with the previous activity, information identifying particular rules engines utilized to initiate activity during the relevant time period (or a portion of the relevant time period) corresponding to the audit request, and the like. Further, it is noted that deriving or obtaining audit data from the blockchain 119 may provide a stronger sense of trustworthiness as compared to obtaining the audit data from the database 118. This is because the blocks of the blockchain 119 comprise immutable records that are not easily modified once added to the blockchain. It is also to be appreciated that audit processes may utilize both audit data derived from the blockchain 119 and the database 118, such as to verify the accuracy of the records stored in the database 118 or identify additional information included in the records of the database 118 that may have been redacted from the information recorded on the blockchain 119, such as information that identifies or associates specific rules engines with transactions resulting in changes to the holdings of the portfolio or information that specifies a version associated with a rules engine during a relevant time period. The accuracy of the records stored in the database 118 may be determined by executing the one or more rules engines in the manner described above using audit data derived from both database 118 and the blockchain 119 and then comparing the results to determine whether any discrepancies may exist. Additionally, by determining particular versions associated with the rules engines during a time period associated with an audit ensures that the recreation of the portfolio activity is not biased by any changes that may have been made to the rules engines subsequent to the time period associated with the audit.

In addition to facilitating audits by third parties, the system 100 may be configured to implement auditing operations, which may facilitate various different forms of oversight with respect to operations of the system 100. The auditing operations may be utilized by the primary authorized participant server 110 to monitor operations of the system 100 and identify anomalies with respect to activities performed utilizing the system 100, such as to identify suspicious trade activity, adverse price movement (e.g., price movement with respect to the shares of the portfolio and/or the underlying traded assets of the portfolio), prior price movements, and the like. For example, during auditing operations it may be discovered that after sending out a portfolio change a particular traded asset or a particular set of traded assets (e.g., one or more stocks held in the portfolio) experience price drops or increases with a discernable pattern. This may indicate potential information leakage with associated front running. In response to identifying the discernable pattern of price fluctuations, the system 100 may flag the activity as “suspicious activity” and an investigation may be initiated to confirm the presence of an information leakage and discover its source. Additionally, price movements associated with portfolio changes over a period of time may result in historical patterns. These historical patterns may be analyzed to determine whether an individual traded asset or group of traded assets exhibit suspicious volatility compared to historical norms. If these prior price movement anomalies are detected, that activity may be flagged by the system 100 and an investigation into the causes of the anomalous price movements may be initiated. It is noted that analysis of price movements and fluctuations may be performed using algorithmic analysis. Stated another way, the system 100 may be configured with pre-determined rules configured to analyze the activities associated with the portfolio to identify the presence of anomalies. By using algorithmic analysis, the results may be deterministic such that the same outcome is produced each time the analysis is performed on a given data set, thereby ensuring the repeatability of the results and ensuring trust in the auditing process. The auditing operations of the primary authorized participant server 110 may be utilized to monitor the performance of the portfolio and the activities associated with the one or more rules engines, which may enable the entity operating the primary authorized participant server 110 to identify underperforming liquidity providers (e.g., liquidity providers that are associated with rules engines that are negatively impacting the performance of the portfolio).

The management server 160 may be configured to perform netting operations. For example, at the end of each day for which the holdings of the portfolio have been modified, the management server 160 may determine net changes to the holdings of the portfolio and the shares of the portfolio based on the operations initiated by the one or more rules engines. Multiple modifications to the holdings and the shares of the portfolio may occur throughout a particular day as a result of the operations initiated by the one or more rules engines and fluctuating market conditions. The net changes may reflect the total (or net) change with respect to the holdings of the portfolio (e.g., to reflect the final quantities of traded assets held in the portfolio at the end of the particular day) and the shares of the portfolio (e.g., to reflect the number of issued shares of the portfolio taking into account any creations and redemptions that may have occurred). The net change information may be utilized to create a settlement record for the portfolio on the particular day, which may be reflected in the holdings file (e.g., a daily or primary holdings file) provided to the primary authorized participant server 110 at the end of a particular trading day.

Although in the description above the primary authorized participant serve 110 is illustrated and described as being separate from the management server 160 and the authorized participant servers 120, embodiments of the present invention are not to be limited to such configurations. For example, in an embodiment the operations of the primary authorized participant server 110 may be performed by management server 160 or may be performed by one of the authorized participant servers 120. It is to be appreciated that the operations of the system 100 described above provide a new approach to the operations associated with creating and managing portfolios of traded assets. For example, the infrastructure utilized to facilitate operations of the system 100, including the blockchain 119 and the primary authorized participant server 110, provides a new approach to providing workflows that support operations associated with portfolios of traded assets. As an example, the primary authorized participant server 110 provides a centralized point of access from which authorized participant servers 120 may receive the holdings files recorded on the blockchain 119, and distribution of the holdings files to the plurality of rules engines facilitates improved trading operations by the authorized participant servers 120. This centralized distribution architecture provides a computational environment that allows for trade engine order/execution, data capture, and post-trade diagnostics designed to ensure that holdings files are appropriately utilized for the benefit of the portfolio shareholders.

Post-trade diagnostics may facilitate various refinements to the operations of the system 100. For example, analytics may be utilized by liquidity providers to modify the rules sets associated with the one or more rules engines, such as to adjust risk tolerances, modify metrics utilized to identify arbitrage opportunities, and the like. Additionally, the authorized participant server 120 may utilize analytics facilitated by the information stored in the blockchain 119 to refine its operations, such as to adjust thresholds associated with adjusting aggregated quantities of shares corresponding to outcomes produced by the one or more rules engines. The analytics may additionally or alternatively be utilized by the authorized participant server 120 to configure priorities associated with one or more marketplace servers 140 (e.g., generate a ranked list of marketplaces) such that marketplace servers 140 that are more advantageous (e.g., faster trade execution times, reduced fees, and the like) are prioritized over less advantageous marketplace servers 140. It is noted that the exemplary analytics operations described above have been provided for purposes of illustration, rather than by way of limitation and that a system implementing the concepts disclosed herein may readily utilize analytics for other purposes as may be desired by the relevant systems, parties, and configuration of the system 100.

Additional benefits provided by the system 100 and the work flows that are supported by the system 100 may include: reduced operational costs and improved performance with respect to distribution of assets (e.g. holdings and/or shares of the portfolio), which may encourage more entities to issue portfolios of traded assets; increased activity for liquidity providers, which may provide increased opportunities to generate revenue/profits from arbitrage operations; reduced operational burdens; increases in the number of portfolios of traded assets available to investors (e.g., due to the decreased costs and other benefits provided by the system 100); true intraday liquidity; and mitigation of front loading and free running by third parties. It is noted that work flows and processes implemented by the various components of the system 100 result in an improved system that may be more efficiently utilized to manage portfolios of traded assets. For example, while many of the operations performed by the system 100 may be similar to operations performed by previous systems, such previous systems operated in isolation from one another and were not capable of realizing the advantages provided by the centralized nature of the system 100, in which multiple rules engines may be operated in coordination with one another to support the portfolio of traded assets. Additionally, it is noted that such improvements are not realized simply by utilizing a computer to perform the operations described herein—instead, the system 100 provides a centralized architecture that facilitates new processes that interact with one another in a coordinated manner to realize the aforementioned processing efficiencies and advantages, such as enabling aggregation of trading activity from multiple rules engines, recording trading activity within immutable records of the blockchain, enabling coordinated and synchronized distribution of holdings files, and the like.

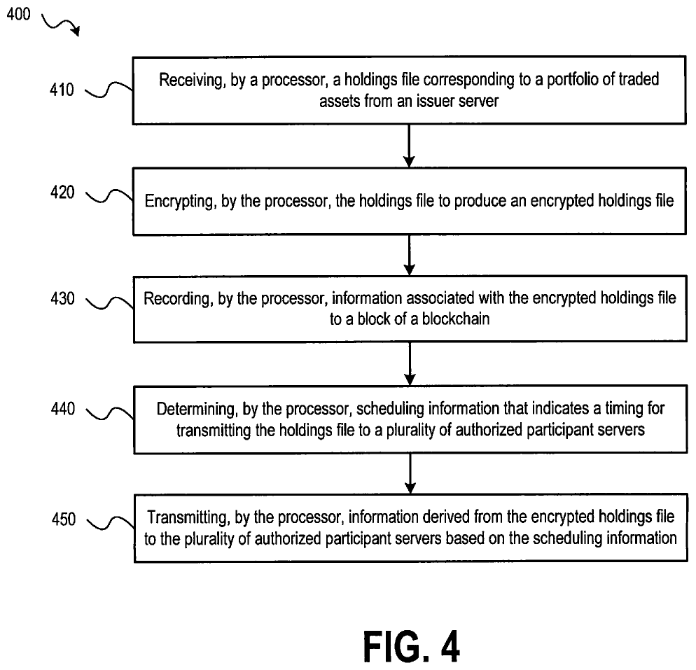

Referring to FIG. 4, a flow diagram of an exemplary method for blockchain-based management a portfolio of traded assets in accordance with embodiments is shown as a method 400. In an embodiment, the method 400 may be performed by the primary authorized participant server 110 of FIG. 1. For example, the steps of the method 400 may be stored as instructions (e.g., the instructions 126 of FIG. 1) that, when executed by one or more processors (e.g., the one or more processors 112 of FIG. 1), cause the one or more processors to perform the steps of the method 400.

At step 410, the method 400 includes receiving a holdings file corresponding to a portfolio of traded assets from an management server. As described above, the holdings file may identify changes to quantities of one or more traded assets held in the portfolio of traded assets. The changes to the quantities of traded assets may be the result of operations of one or more primary authorized participant servers, as described above. At step 420, the method 400 includes encrypting the holdings file to produce an encrypted holdings file. At step 430, the method 400 includes recording information associated with the encrypted holdings file to a block of a blockchain. As described above, recording the information associated with the encrypted holdings file to the block of the blockchain may include determining an address corresponding to a last block of the blockchain and generating the block, which may include information corresponding to the last block of the blockchain, the information associated with the encrypted holdings file, and a timestamp. The information associated with the encrypted holdings file may include at least a portion of the encrypted holdings file. Additionally or alternatively include generating a hash of the holdings file and the information associated with the encrypted holdings file may include the hash of the holdings file. When the hash of the encrypted holdings file is recorded to the blockchain, the encrypted holdings file may be stored in a database.

At step 440, the method 400 includes determining scheduling information that indicates a timing for transmitting the holdings file to a plurality of authorized participant servers. At step 450, the method includes transmitting information derived from the encrypted holdings file to the plurality of authorized participant servers based on the scheduling information. Determining the scheduling information may include calculating a threshold amount of time based on an amount of time associated with processing the holdings file via a plurality of rules engines, where each rules engine of the plurality of rules engines corresponds to one of the plurality authorized participant servers. Additionally, determining the scheduling information may include determining one or more times associated with opening of trading activity at one or more marketplace servers, and the timing indicated by the scheduling information may be configured to initiate transmission of the holdings file to the plurality of authorized participant servers such that each of the plurality of authorized participant servers has sufficient time to process the holdings file prior to an opening of trading activity at the one or more marketplace servers.

In an aspect, the method 400 may include receiving an audit request from a requestor device, as described above, and retrieving information from one or more blocks of the blockchain in response to the audit request. The audit request may identify a time period and the one or more blocks of the blockchain may include information associated with holdings files generated during the time period indicated by the audit request. The method 400 may include generating audit data based on the information retrieved from the one or more blocks of the blockchain and transmitting the audit data to the requestor device. The audit data may include information associated with changes to quantities of the one or more traded assets held in the portfolio during the time period. When the information associated with holdings files includes hash values associated with a plurality of holdings files the method may include retrieving one or more records from a database, where each of the one or more records in the database may include an encrypted holdings file. The method may include decrypting each of the encrypted holdings files, generating a hash value for each of the encrypted holdings files, and comparing the hash values generated for each of the encrypted holdings files to the hash values obtained from the one or more blocks of the blockchain to determine an authenticity of the encrypted holdings files. The audit data may include information that indicates the authenticity of the encrypted holdings files.

Although aspects of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A method comprising:
receiving, by a processor, a holdings file corresponding to a portfolio of traded assets from an management server, wherein the holdings file identifies changes to quantities of one or more traded assets held in the portfolio of traded assets;
encrypting, by the processor, the holdings file to produce an encrypted holdings file;
recording, by the processor, information associated with the encrypted holdings file to a block of a blockchain;
determining, by the processor, scheduling information that indicates a timing for transmitting the holdings file to a plurality of authorized participant servers; and
transmitting, by the processor, information derived from the encrypted holdings file to the plurality of authorized participant servers based on the scheduling information.

2. The method of claim 1, wherein recording the information associated with the encrypted holdings file to the block of the blockchain comprises:
determining an address corresponding to a last block of the blockchain;
generating the block, wherein the block comprises information corresponding to the last block of the blockchain, the information associated with the encrypted holdings file, and a timestamp.

3. The method of claim 2, wherein the information associated with the encrypted holdings file comprises at least a portion of the encrypted holdings file.

4. The method of claim 2, further comprising generating a hash of the holdings file, wherein the information associated with the encrypted holdings file comprises the hash of the holdings file.

5. The method of claim 4, further comprising storing the encrypted holdings file in a database.

6. The method of claim 1, wherein determining the scheduling information that indicates the timing for transmitting the holdings file to the plurality of authorized participant servers comprises:
calculating a threshold amount of time based on an amount of time associated with processing the holdings file via a plurality of rules engines, wherein each rules engine of the plurality of rules engines corresponds to one of the plurality authorized participant servers;
determining one or more times associated with opening of trading activity at one or more marketplace servers, wherein the timing indicated by the scheduling information is configured to initiate transmission of the holdings file to the plurality of authorized participant servers such that each of the plurality of authorized participant servers has sufficient time to process the holdings file prior to an opening of trading activity at the one or more marketplace servers.

7. The method of claim 1, further comprising:
receiving an audit request from a requestor device;
retrieving information from one or more blocks of the blockchain in response to the audit request; and
generating audit data based on the information retrieved from the one or more blocks of the blockchain; and
transmitting the audit data to the requestor device.

8. The method of claim 7, wherein the audit request identifies a time period, wherein the one or more blocks of the blockchain comprise information associated with holdings files generated during the time period, and wherein the audit data comprises information associated with changes to quantities of the one or more traded assets held in the portfolio during the time period.

9. The method of claim 7, wherein the information associated with holdings files comprises hash values associated with a plurality of holdings files, and wherein the method further comprises:
retrieving one or more records from a database, wherein each of the one or more records comprises an encrypted holdings file;
decrypting each of the encrypted holdings files;
generating a hash value for each of the encrypted holdings files;
comparing the hash values generated for each of the encrypted holdings files to the hash values obtained from the one or more blocks of the blockchain to determine an authenticity of the encrypted holdings files, wherein the audit data comprises information that indicates the authenticity of the encrypted holdings files.

10. A non-transitory computer-readable medium storing instructions that, when executed by one or more processors, cause the one or more processors to perform operations, the operations comprising:
receiving a holdings file corresponding to a portfolio of traded assets from an management server, wherein the holdings file identifies changes to quantities of one or more traded assets held in the portfolio of traded assets;
encrypting the holdings file to produce an encrypted holdings file;
recording information associated with the encrypted holdings file to a block of a blockchain;
determining scheduling information that indicates a timing for transmitting the holdings file to a plurality of authorized participant servers; and
transmitting information derived from the encrypted holdings file to the plurality of authorized participant servers based on the scheduling information.

11. The non-transitory computer-readable medium of claim 10, wherein recording the information associated with the encrypted holdings file to the block of the blockchain comprises:
determining an address corresponding to a last block of the blockchain;
generating the block, wherein the block comprises information corresponding to the last block of the blockchain, the information associated with the encrypted holdings file, and a timestamp.

12. The non-transitory computer-readable medium of claim 11, wherein the information associated with the encrypted holdings file comprises at least a portion of the encrypted holdings file.

13. The non-transitory computer-readable medium of claim 11, the operations further comprising generating a hash of the holdings file, wherein the information associated with the encrypted holdings file comprises the hash of the holdings file.

14. The non-transitory computer-readable medium of claim 13, further comprising storing the encrypted holdings file in a database.

15. The non-transitory computer-readable medium of claim 10, wherein determining the scheduling information that indicates the timing for transmitting the holdings file to the plurality of authorized participant servers comprises:
calculating a threshold amount of time based on an amount of time associated with processing the holdings file via a plurality of rules engines, wherein each rules engine of the plurality of rules engines corresponds to one of the plurality authorized participant servers;
determining one or more times associated with opening of trading activity at one or more marketplace servers, wherein the timing indicated by the scheduling information is configured to initiate transmission of the holdings file to the plurality of authorized participant servers such that each of the plurality of authorized participant servers has sufficient time to process the holdings file prior to an opening of trading activity at the one or more marketplace servers.

16. The non-transitory computer-readable medium of claim 11, the operations further comprising:
receiving an audit request from a requestor device;
retrieving information from one or more blocks of the blockchain in response to the audit request; and
generating audit data based on the information retrieved from the one or more blocks of the blockchain; and
transmitting the audit data to the requestor device.

17. The non-transitory computer-readable medium of claim 16, wherein the audit request identifies a time period, wherein the one or more blocks of the blockchain comprise information associated with holdings files generated during the time period, and wherein the audit data comprises information associated with changes to quantities of the one or more traded assets held in the portfolio during the time period.

18. The non-transitory computer-readable medium of claim 16, wherein the information associated with holdings files comprises hash values associated with a plurality of holdings files, and wherein the operations further comprise:
retrieving one or more records from a database, wherein each of the one or more records comprises an encrypted holdings file;
decrypting each of the encrypted holdings files;
generating a hash value for each of the encrypted holdings files;
comparing the hash values generated for each of the encrypted holdings files to the hash values obtained from the one or more blocks of the blockchain to determine an authenticity of the encrypted holdings files, wherein the audit data comprises information that indicates the authenticity of the encrypted holdings files.

19. A system comprising:
a memory; and
at least one processor communicatively coupled to the memory, wherein the processor is configured to:
receive a holdings file corresponding to a portfolio of traded assets from an management server, wherein the holdings file identifies changes to quantities of one or more traded assets held in the portfolio of traded assets;
encrypt the holdings file to produce an encrypted holdings file;
record information associated with the encrypted holdings file to a block of a blockchain;
determine scheduling information that indicates a timing for transmitting the holdings file to a plurality of authorized participant servers; and
transmit information derived from the encrypted holdings file to the plurality of authorized participant servers based on the scheduling information.

20. The system of claim 19, wherein recording the information associated with the encrypted holdings file to the block of the blockchain comprises:
determining an address corresponding to a last block of the blockchain;
generating the block, wherein the block comprises information corresponding to the last block of the blockchain, the information associated with the encrypted holdings file, and a timestamp.

21. The system of claim 20, wherein the information associated with the encrypted holdings file comprises at least a portion of the encrypted holdings file.

22. The system of claim 20, wherein the at least one processor is configured to generate a hash of the holdings file, and wherein the information associated with the encrypted holdings file comprises the hash of the holdings file.

23. The system of claim 22, wherein the at least one processor is configured to store the encrypted holdings file in a database.

24. The system of claim 19, wherein determining the scheduling information that indicates the timing for transmitting the holdings file to the plurality of authorized participant servers comprises:
calculating a threshold amount of time based on an amount of time associated with processing the holdings file via a plurality of rules engines, wherein each rules engine of the plurality of rules engines corresponds to one of the plurality authorized participant servers;
determining one or more times associated with opening of trading activity at one or more marketplace servers, wherein the timing indicated by the scheduling information is configured to initiate transmission of the holdings file to the plurality of authorized participant servers such that each of the plurality of authorized participant servers has sufficient time to process the holdings file prior to an opening of trading activity at the one or more marketplace servers.

25. The system of claim 19, wherein the at least one processor is configured to:
receive an audit request from a requestor device;
retrieve information from one or more blocks of the blockchain in response to the audit request; and
generate audit data based on the information retrieved from the one or more blocks of the blockchain; and
transmit the audit data to the requestor device.

26. The system of claim 25, wherein the audit request identifies a time period, wherein the one or more blocks of the blockchain comprise information associated with holdings files generated during the time period, and wherein the audit data comprises information associated with changes to quantities of the one or more traded assets held in the portfolio during the time period.

27. The system of claim 25, wherein the information associated with holdings files comprises hash values associated with a plurality of holdings files, and wherein the at least one processor is configured to:
retrieve one or more records from a database, wherein each of the one or more records comprises an encrypted holdings file;
decrypt each of the encrypted holdings files;
generate a hash value for each of the encrypted holdings files;
compare the hash values generated for each of the encrypted holdings files to the hash values obtained from the one or more blocks of the blockchain to determine an authenticity of the encrypted holdings files, wherein the audit data comprises information that indicates the authenticity of the encrypted holdings files.
